(19) United States
(12) Patent Application Publication
(10) Pub. No.: US 2019/0202194 A1
(43) Pub. Date: Jul. 4, 2019

(54) ORIGINAL PLATE FOR FORMING INK FILM, PATTERN FORMING METHOD, PATTERN FILM FORMING METHOD, AND PATTERN FILM FORMING APPARATUS

(71) Applicant: Konica Minolta, Inc., Tokyo (JP)

(72) Inventors: Kengo IKEDA, Kitamoto-shi (JP); Mayuko MATSUSAKI, Tokyo (JP); Hirofumi HAYATA, Tokyo (JP)

(21) Appl. No.: 16/211,939

(22) Filed: Dec. 6, 2018

(30) Foreign Application Priority Data
Dec. 28, 2017 (JP) 2017-253003

(51) Int. Cl. B41F 7/20; B41M 1/06

(52) U.S. Cl. CPC B41F 7/20; B41M 1/06

(57) ABSTRACT

An original plate for forming an ink film includes a surface layer including a stimulus-responsive compound which responds to an external stimulus to have reversibly changed affinity with water; and a resin.

### CROSS-REFERENCE TO RELATED APPLICATION

The entire disclosure of Japanese Patent Application No. 2017-253003, filed on Dec. 28, 2017, is incorporated herein by reference in its entirety.

### BACKGROUND

### 1. Technical Field

The present invention relates to an original plate for forming an ink film and a pattern forming method thereof, a pattern film forming method using the original plate, and a pattern film forming apparatus.

### 2. Description of Related Arts

There are representatively two methods in lithography. One is a method of performing printing by providing a hydrophilic portion and a hydrophobic portion on a surface of a flat plate, pre-soaking the hydrophilic portion to wet the hydrophilic portion in water, coating an ink which is immiscible with water on the surface of the flat plate to form a liquid film structure having the ink only on the hydrophobic portion, and transferring the liquid film structure. The other one is anhydrous lithography, in which from a flat plate in which a photosensitive layer and a silicone rubber layer are stacked in this order, a portion of the photosensitive layer with the silicone rubber or only the silicone rubber is removed by partial light exposure and development, thereby performing printing using the flat plate on which a pattern having a non-image portion in which the silicone rubber layer is the surface and an image portion in which at least the silicone rubber layer is removed, is formed without using water.

In the lithography, it is considered at first that a printing plate surface has a convex shape or a concave shape, however, for example, in the anhydrous lithography method, there is a step having a thickness at least equal to or more than the thickness of the silicone rubber layer, between the image portion and the non-image portion formed on the flat plate, and thus, strictly speaking, the plate cannot be flat. In addition, since the flat plate is formed by performing processes of coating, light exposure, and development, the man-hour is long, and the flat plate is not formed by a simple process. Furthermore, as seen from the manufacturing process, it is not easy to rewrite the pattern of the flat plate.

That is, in the case of the conventional lithography (analog printing), it is not easy to change the flat plate on which a print pattern was formed once, and every time another printed matter is printed, the flat plate needs to be newly manufactured from the beginning, and thus, there is a problem in that time loss occurs or costs are increased, due to the manufacture of the flat plate.

As a means to reduce the time loss or the costs, in the field of analog printing also, manufacturing the flat plate digitally, that is, digital plate making, is in progress. As the technique for the digital plate making, for example, Japanese Patent Application Laid-Open No. 2016-175192 suggests a pattern film forming method using first and second blankets having a surface for an ink film composed of a single material. It is a technique, in which the surface composed of the single material is partially subjected to chemical or physical treatment, thereby forming the surface for an ink film composed of a high adhesive site and a low adhesive site (in which a step between the high adhesive site and the low adhesive site is 100 nm or less), and the same material as the blanket material is overcoated and cured, thereby rewriting the plate. In addition, Japanese Patent Application Laid-Open No. 2016-175192 discloses that when a single material is a functional molecule (photoresponsive molecule or thermoresponsive molecule), rewriting is possible without performing the overcoating.

### SUMMARY

However, the technique described in Japanese Patent Application Laid-Open No. 2016-175192 has a problem of deteriorated durability of the flat plate, since the surface of the flat plate is composed of a single material.

Therefore, an object of the present invention is to provide an original plate for forming an ink film which is easy to digitally rewrite a pattern thereon, and has excellent durability.

The inventors of the present invention conducted a study extensively, and as a result, found that the problems are solved by the following original plate for forming an ink film, thereby completing the present invention.

In order to realize at least one of the above-described objects, the original plate for forming an ink film on which an aspect of the present invention is reflected has a surface layer including a stimulus-responsive compound, which responds to an external stimulus to have reversibly changed affinity with water, and a resin.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic drawing representing a pattern film forming apparatus according to an embodiment of the present invention, in which reference number 1 denotes an original plate for forming an ink film, reference number 2 denotes a plate cylinder, reference number 3 denotes a blanket, reference number 4 denotes an impression cylinder, reference number 5 denotes an ink roller, reference number 6 denotes a water roller, reference number 7 denotes a single color laser light source, reference number 8 denotes an object to be printed, and reference number 10 denotes a pattern film forming apparatus, respectively;

FIG. 2 is a drawing representing an image pattern used in evaluation; and

FIG. 3 is a drawing representing an intersection of thin lines used in evaluation.

### DETAILED DESCRIPTION

Hereinafter, one or more embodiments of the present invention will be described with reference to the drawings. However, the scope of the invention is not limited to the disclosed embodiments. In the description of the drawings, the same elements are denoted by the same reference numerals, and redundant description is omitted. In addition, in some cases, dimensional ratios in the drawings are exaggerated and different from actual ratios for convenience of the description.

An embodiment of the present invention is an original plate for forming an ink film having a surface layer including a stimulus-responsive compound, which responds to an external stimulus to have reversibly changed affinity with water, and a resin. The original plate for forming an ink film having the constitution is easy to digitally rewrite a pattern thereon, and has excellent durability. The original plate for forming an ink film of the present invention is hereinafter, also referred to as “an original printing plate” or “an original plate”.

Details are unclear as to why the above effects are obtained by the original plate of the present invention, however, the following mechanism can be considered. The following mechanism was obtained by speculation, and the present invention is not limited to the following mechanism at all.

In the case that the original plate having a surface composed of a single material is used, as in the technique described in the above-mentioned Japanese Patent Application Laid-Open No. 2016-175192, it was confirmed that when rewriting and image output are repeated, the surface of the original plate is weakened by deterioration of the single material, thereby deteriorating the reproducibility of thin lines, which means that the durability of the original plate is problematic.

Meanwhile, the original plate according to an embodiment of the present invention has a surface layer including a stimulus-responsive compound which responds to an external stimulus to have reversibly changed affinity with water, and resin. Since the surface layer includes the resin as well as the stimulus-responsive compound, a reduced mechanical load to the stimulus-responsive compound, suppressed degradation of the stimulus-responsive compound, or the like becomes possible, whereby strength of the surface layer can be increased. In addition, rapid stimulus responsiveness of the stimulus-responsive compound is maintained. Therefore, the original plate according to an embodiment of the present invention is easy to digitally rewrite a pattern thereon, and has excellent durability in that even in the case of repeatedly rewriting a pattern, small letters and fine images can be printed clearly and reproducibly.

As described above, the original plate for forming an ink film according to an embodiment of the present invention has a surface layer including the stimulus-responsive compound, which responds to an external stimulus to have reversibly changed affinity with water, and the resin. By the constitution, according to the present invention, an original plate for forming an ink film which is easy to digitally rewrite a pattern thereon, and has excellent durability can be provided.

Hereinafter, the constitution of the original plate for forming an ink film according to an embodiment of the present invention will be described in detail.

In the present specification, “X to Y” representing a range refers to “X or more and Y or less”. In addition, in the present specification, unless otherwise stated, measurement of operation and physical properties is performed under the condition of room temperature (20 to 25° C.)/relative humidity of 40 to 50% RH.

### Original Plate for Forming an Ink Film

### Constitution of Original Plate

The original plate for forming an ink film according to an embodiment of the present invention is usually formed by disposing a surface layer including a stimulus-responsive compound and a resin on a support.

### Support

The shape of the support is not particularly limited, and may be a flat shape, a cylindrical shape, and the like.

The materials of the support are also not particularly limited, however, for example, may be metals such as aluminum, an aluminum alloy (such as an alloy of aluminum and magnesium and/or silicon), iron and stainless steel, plastics such as polyethylene terephthalate (PET), polybutylene terephthalate (PBT), polyacrylonitrile, polyvinyl chloride, an epoxy resin, a phenol resin, styrene-butadiene rubber, and the like. These may be used alone or in combination of two or more.

The support may have any form of a single layer or multiple layers. In addition, in the case of the multiple layers, each layer may include different materials.

### Surface Layer

### Resin

The resin included in the surface layer is not particularly limited, and any one of a thermoplastic resin and a thermosetting resin can be used.

An example of the thermoplastic resin may include, for example, a polyolefin resin such as polyethylene and polypropylene, a cyclic polyolefin resin, a polyester resin such as polyethylene terephthalate and polybutylene terephthalate, a polyvinyl chloride resin, a polyvinylidene chloride resin, a polytetrafluoroethylene resin, a polystyrene resin, a polyether resin, a polyvinyl acetate resin, an acrylonitrile⋅butadiene⋅styrene (ABS) resin, an acrylonitrile⋅styrene (AS) resin, an acryl resin, a styrene acryl resin, a polyamide resin, a polyacetal resin, a polycarbonate resin, a modified polyphenylene ether resin, a polybutylene terephthalate resin, a polyethylene terephthalate resin, a polyphenylene sulfide resin, a polysulfone resin, a polyethersulfone resin, an amorphous polyacrylate resin, a liquid crystal polymer, a polyetheretherketone resin, a thermoplastic polyimide resin, a polyamideimide resin, copolymers thereof, or the like.

An example of the thermosetting resin may include a solid epoxy resin, a silicone resin, a silicone-modified resin, a formaldehyde resin, a phenol resin, a melamine resin, an urea resin, a benzoguanamine resin, an unsaturated polyester resin, an alkyd resin, a diallyl phthalate resin, a polyurethane resin, a thermosetting polyimide resin, a crosslinking acryl resin (e.g., a crosslinking polymethylmethacrylate resin), a crosslinking polystyrene resin, a polyamic acid resin (a resin having a polyimide structure formed by imidization by heating), or the like.

The resin may be used alone or in combination of two or more. In addition, for example, a hybrid resin formed by bonding two or more polymerization segments (resin segments) with each other, such as a resin having a vinyl polymerization segment (vinyl resin segment) and a polyester polymerization segment (polyester resin segment), may be used.

Among them, from the viewpoint that change in the affinity of the stimulus-responsive compound with water occurs more easily, the thermoplastic resin is preferred, and the styrene acryl resin, the polycarbonate resin, the polyethylene terephthalate resin, and the polyolefin resin are more preferred.

As the resin included in the surface layer, a synthetic product may be used, or a commercially available product may be used. An example of the commercially available product of resins may include VS-1063 (weight average molecular weight: 5,500), US-1071 (weight average molecular weight: 10,000), X-1 (weight average molecular weight: 18,000), YS-1274 (weight average molecular weight: 19,000), VS-1047 (weight average molecular weight: 10,000), RS-1191 (weight average molecular weight: 6,500), or the like which is manufactured by SEIKO PMC CORPORATION.

The weight average molecular weight of the resin included in the surface layer is not particularly limited, however, the weight average molecular weight in a range of 5,000 to 30,000 is preferred, and the weight average molecular weight in a range of 8,000 to 20,000 is more preferred.

The content of the resin in the surface layer is preferably 30 to 80% by mass, and more preferably 40 to 70% by mass, based on the total mass of the stimulus-responsive compound and the resin included in the surface layer. Within the range mentioned above, rapid stimulus responsiveness can be maintained, and the strength of the surface layer can be improved.

In the present specification, as the weight average molecular weight, the value measured by gel permeation chromatography (GPC) is adopted.

### Stimulus-Responsive Compound

The stimulus-responsive compound refers to a compound which responds to an external stimulus to reversibly change the properties. In the present invention, the stimulus-responsive compound which responds to an external stimulus to have reversibly changed affinity with water is used.

In addition, responding to an external stimulus to have reversibly changed affinity with water means that a compound which receives an external stimulus responds to the external stimulus, thereby being reversibly changed between hydrophilicity and hydrophobicity.

Here, “being reversibly changed between hydrophilicity and hydrophobicity” means that the presence state of a molecule is changed by response to an external stimulus, so that hydrophilicity and hydrophobicity are changed. The presence state of a molecule refers to a molecular structure or a molecular aggregation state. For example, when the compound is a photoresponsive compound, the compound responds to light to have a changed molecular structure, thereby controlling hydrophilicity and hydrophobicity depending on whether a hydroxy group is oriented on the surface or not, and when the compound is the temperature-responsive compound, the compound responds to temperature to have a changed molecular aggregation state, thereby controlling hydrophilicity and hydrophobicity.

The external stimulus is not particularly limited, however, for example, may be light, a temperature change, pressure, an electric field, pH, and the like.

An example of the stimulus-responsive compound may include a photoresponsive compound which responds to light to have a reversibly changed affinity with water, a temperature-responsive compound which responds to temperature change to have a reversibly changed affinity with water, an electric field-responsive compound which responds to an electric field to have a reversibly changed affinity with water, a pH-responsive compound which responds to pH to have a reversibly changed affinity with water, or the like.

As the stimulus-responsive compound, a synthetic product may be used, or a commercially available product may be used. In addition, the stimulus-responsive compound may be used alone or in combination of two or more. Among them, from the viewpoint of a rapid rate of change of the affinity with water, the photoresponsive compound or the temperature-responsive compound is preferred.

Hereinafter, the photoresponsive compound and the temperature-responsive compound, which are the preferred stimulus-responsive compound, will be described.

### Photoresponsive Compound

The photoresponsive compound according to the present invention is a compound which causes stereoisomerization or structural isomerization (cis-trans isomerization, a ring-opening reaction by light, or the like) by light irradiation to have a reversibly changed affinity with water. The compound may include, specifically, a compound having an azobenzene structure including a hydrophilic group, a compound having a spiropyran structure including a hydrophilic group, a compound having a stilbene structure including a hydrophilic group, a compound having a diarylethene structure including a hydrophilic group, and the like. These compounds may be in the form of a polymer or a crosslinked body of the polymer.

Among them, from the viewpoint of a rapid rate of change of the affinity with water, the compound having an azobenzene structure including a hydrophilic group, or the compound having a stilbene structure including a hydrophilic group which causes cis-trans isomerization by light irradiation is preferred.

An example of the hydrophilic group may include a hydroxy group, a carboxy group, a mercapto group, a sulfonic acid group, a sulfuric acid group, a phosphoric acid group, an amino group, or the like. These hydrophilic groups may be one or a combination of two or more. Among them, from the viewpoint of a rapid rate of change of the affinity with water, it is preferred that the hydrophilic group is a hydroxy group.

It is preferred that the compound having an azobenzene structure including a hydrophilic group is specifically represented by the following Chemical Formula 1.

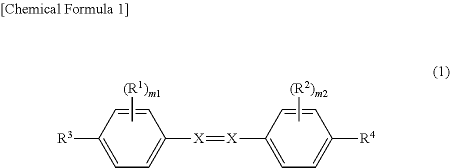

In Chemical Formula 1, R¹ and R² are independently from each other a hydrophilic group; R³ and R⁴ are independently from each other an alkyl group or an alkoxy group having 1 to 18 carbon atoms; and m1 and m2 are independently from each other an integer of 0 to 4, however, m1+m2 is an integer of 1 to 8.

R¹ and R² of Chemical Formula 1 are independently from each other a hydrophilic group. An example of the hydrophilic group is as described above. When m1+m2 is an integer of 2 to 8, a plurality of hydrophilic groups may be identical to or different from each other.

R³ and R⁴ of Chemical Formula 1 are independently from each other an alkyl group having 1 to 18 carbon atoms or an alkoxy group having 1 to 18 carbon atoms.

An example of the alkyl group having 1 to 18 carbon atoms may include linear alkyl groups such as a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group; branched alkyl groups such as an isopropyl group, an isobutyl group, a sec-butyl group, a t-butyl group, an isoamyl group, a t-pentyl group, a neopentyl group, a 1-methyl pentyl group, a 4-methyl-2-pentyl group, a 3,3-dimethyl butyl group, a 2-ethyl butyl group, a 1-methyl hexyl group, a t-octyl group, a 1-methyl heptyl group, a 2-ethyl hexyl group, a 2-propyl pentyl group, a 2,2-dimethyl heptyl group, a 2,6-dimethyl-4-heptyl group, a 3,5,5-trimethyl hexyl group, a 1-methyl decyl group, and a 1-hexyl heptyl group; or the like.

An example of the alkoxy group having 1 to 18 carbon atoms may include linear alkoxy groups such as a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, and an n-hexadecyloxy group; branched alkoxy groups such as an isopropoxy group, a t-butoxy group, a 1-methyl pentyloxy group, a 4-methyl-2-pentyloxy group, a 3,3-dimethyl butyloxy group, a 2-ethyl butyloxy group, a 1-methyl hexyloxy group, a t-octyloxy group, a 1-methyl heptyloxy group, a 2-ethyl hexyloxy group, a 2-propyl pentyloxy group, a 2,2-dimethyl heptyloxy group, a 2,6-dimethyl-4-heptyloxy group, a 3,5,5-trimethyl hexyloxy group, a 1-methyl decyloxy group, and a 1-hexyl heptyloxy group; or the like.

A more specific example of the compound having an azobenzene structure including a hydrophilic group may include the compounds represented by the following Chemical Formulae 2 and 3:

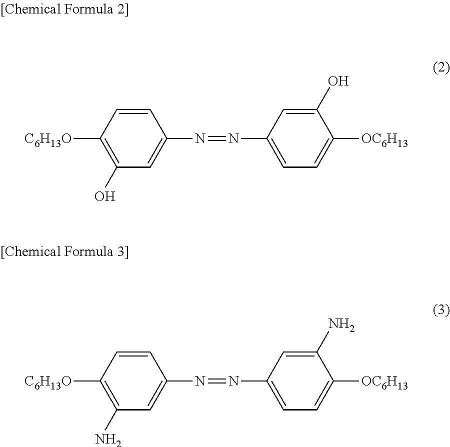

It is preferred that the compound having a stilbene structure including a hydrophilic group is specifically represented by the following Chemical Formula 4:

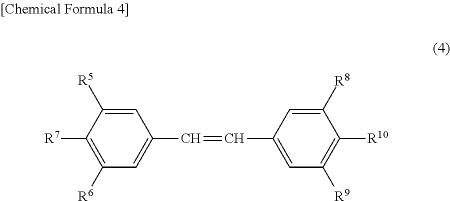

In Chemical Formula 4, R⁵ to R¹⁰ are independently from one another a hydrogen atom, an alkoxy group having 1 to 6 carbon atoms, or a hydrophilic group, in which at least one of R⁵ to R¹⁰ is a hydrophilic group.

An example of the alkoxy group having 1 to 6 carbon atoms may include a methoxy group, an ethoxy group, an n-propoxy group, an isopropoxy group, an n-butoxy group, an isobutoxy group, a sec-butoxy group, a t-butoxy group, an n-pentyloxy group, an isopentyloxy group, a sec-pentyloxy group, a t-pentyloxy group, and an n-hexyloxy group.

An example of the hydrophilic group is as described above.

A more specific example of the compound having a stilbene structure including a hydrophilic group may include preferably the compound represented by the following Chemical Formula 5 (Isorhapontigenin, 3,4′,5-trihydroxy-3′-methoxy-trans-stilbene):

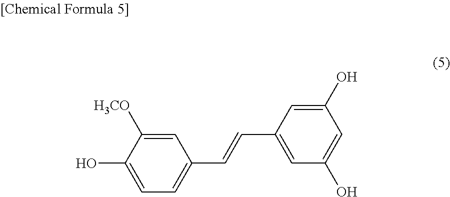 [SMILES: COc1cc(/C=C/c2cc(O)cc(O)c2)ccc1O]

An example of the photoresponsive compound in a polymer form may preferably include a polymer represented by the following Chemical Formula 6:

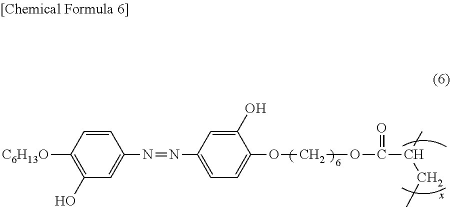

In Chemical Formula 6, x is the number of repeating units, and though it is not particularly limited in a high molecular range, x is for example, in a range of 200 to 1000.

The photoresponsive compound may be used alone or in combination of two or more. In addition, as the photoresponsive compound, a commercially available product may be used, or a synthetic product may be used.

An example of a method of synthesizing the compound having an azobenzene structure including a hydrophilic group may include the following method.

For example, as a method of synthesizing an azobenzene compound represented by Chemical Formula 2, a method represented by the following Reaction Formula A may be included. 2-Chloro-4-aminophenol and sodium nitrite are reacted under a cooling condition to synthesize a diazonium salt, which is reacted with 2-chlorophenol, and then reacted with n-bromohexane, thereby synthesizing Intermediate B. Subsequently, obtained Intermediate B is reacted with an aqueous sodium hydroxide solution, and treated with an acid, whereby the azobenzene compound represented by Chemical Formula 2 (azobenzene derivative (1)) can be obtained.

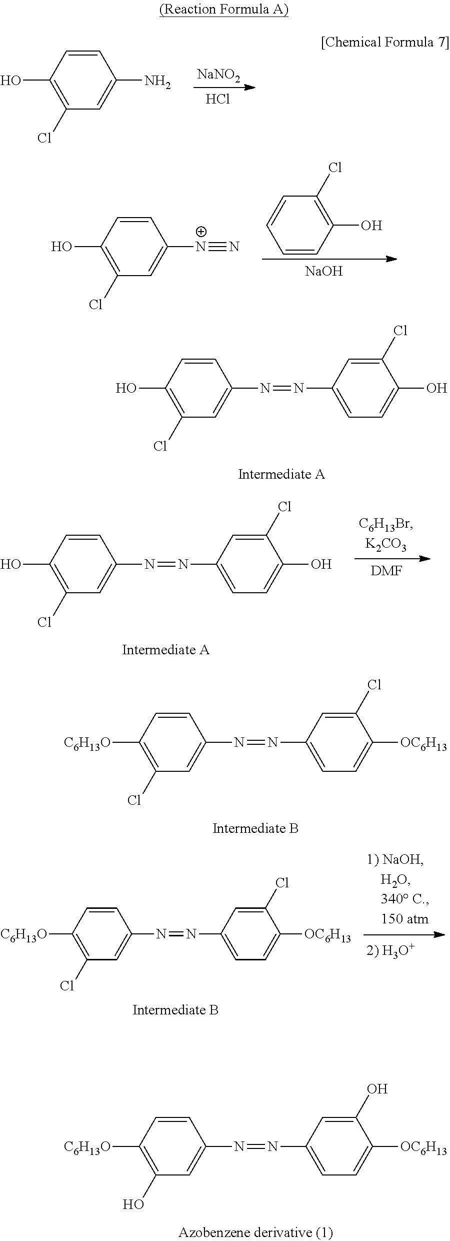

For example, as a method of synthesizing the azobenzene compound represented by Chemical Formula 3 (azobenzene derivative (3)), a method of reacting Intermediate B of Reaction Formula A with potassium amide in liquid ammonia may be included (see the following Reaction Formula B).

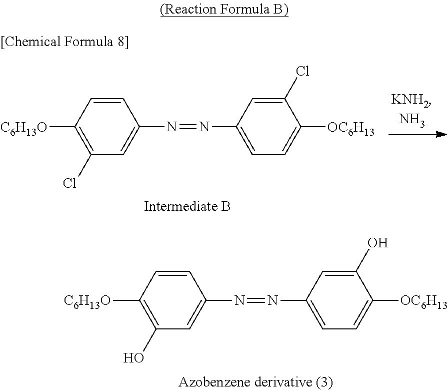

For example, as a method of synthesizing a polymer represented by Chemical Formula 6, a method represented by the following Reaction Formula C may be included. In the same manner as in the above Reaction Formula A, a diazonium salt is synthesized, which is reacted with 2-chlorophenol to obtain Intermediate C, and successively reacted with n-bromohexanol, thereby synthesizing Intermediate D. Subsequently, Intermediate D and acrylic acid chlorides are reacted in the presence of triethylamine to produce an acrylate monomer (Intermediate E) including an azobenzene structure, and a chloro group is converted into a hydroxy group, thereby obtaining Intermediate F. Intermediate F obtained is subjected to a polymerization reaction using 2,2′-azobisisobutyronitrile (AIBN) as a polymerization initiator, whereby an azobenzene compound (azobenzene derivative (Polymer 2)) represented by Chemical Formula 6 can be obtained.

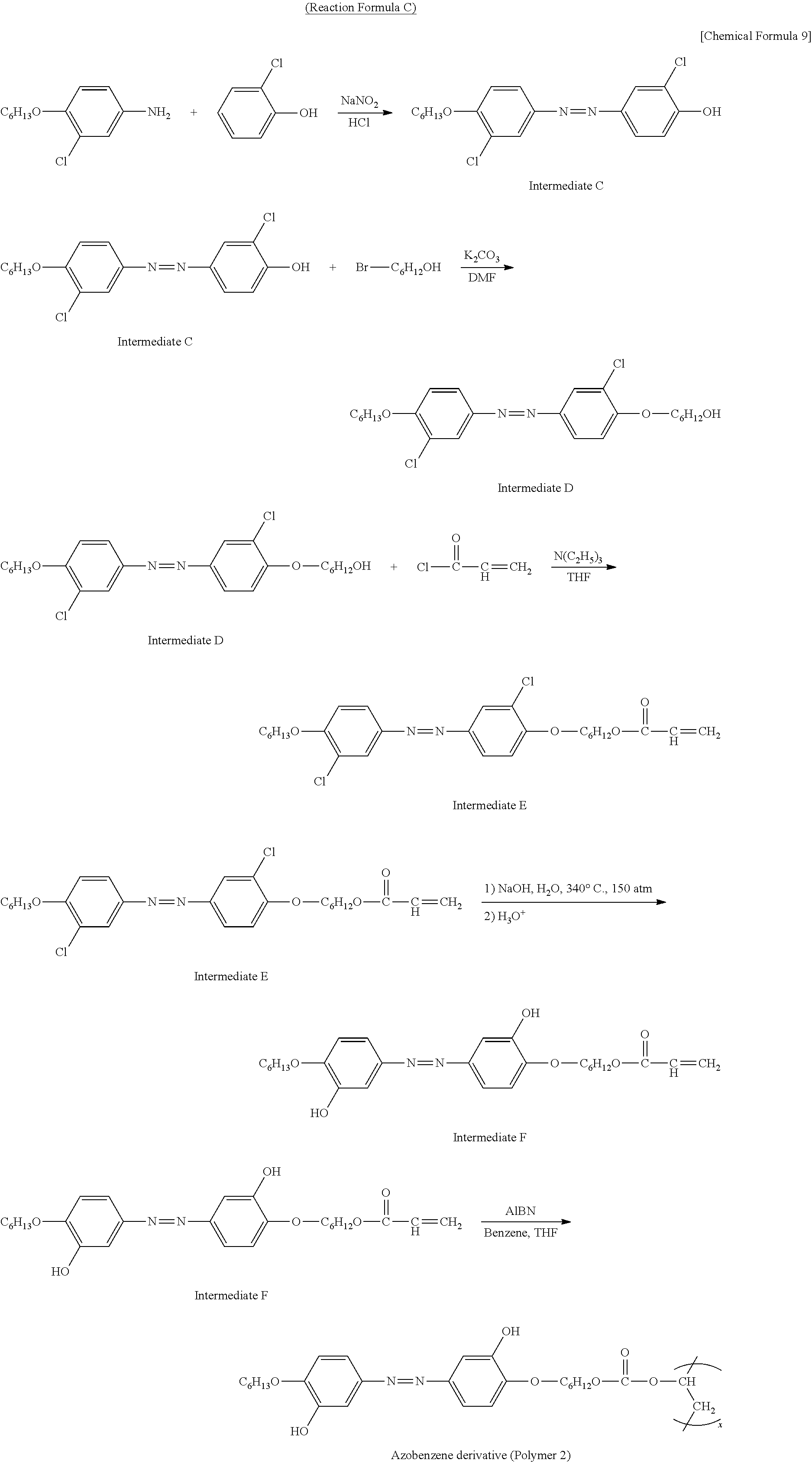

### Temperature-Responsive Compound

The temperature-responsive compound according to the present invention is a compound which responds to a temperature change to have a reversibly changed affinity with water. The temperature-responsive compound is reversibly changed from hydrophobic (or hydrophilic) to hydrophilic (or hydrophobic), at a critical solution temperature (CST) in water. As the temperature-responsive compound, both of the following can be used:

(1) a temperature-responsive compound being hydrophilic at a temperature less than a critical solution temperature (this critical solution temperature being particularly referred to as “a lower critical solution temperature (LCST)”, but being hydrophobic at a temperature equal to or more than the temperature, and

(2) a temperature-responsive compound being hydrophilic at a temperature equal to or more than a critical solution temperature (this critical solution temperature being particularly referred to as “an upper critical solution temperature (UCST)”), but being hydrophobic at a temperature less than the temperature.

The temperature-responsive compound is not particularly limited, but may include an acrylic polymer, a methacrylic polymer, and the like. As a specific example thereof, for example, polymers having a constituent unit derived from N-substituted (meth)acrylamide such as poly(N-n-propyl acrylamide) (LCST: 21° C.), poly(N-n-propyl methacrylamide) (LCST: 27° C.), poly(N-isopropyl acrylamide) (LCST: 32° C.), poly(N-isopropyl methacrylamide) (LCST: 43° C.), poly(N-ethoxy ethyl acrylamide) (LCST: about 35° C.), poly(N-tetrahydro furfuryl acrylamide) (LCST: about 28° C.), poly(N-tetrahydro furfuryl methacrylamide) (LCST: about 35° C.), poly(N,N-diethyl acrylamide) (LCST: 32° C.), poly-N,N-ethyl methyl acrylamide (LCST: 56° C.), poly(N-ethyl acrylamide), poly(N-cyclopropyl acrylamide) (LCST: 45° C.) and poly(N-cyclopropyl methacrylamide), poly(N-acryloylpyrrolidine), poly(N-acryloylpiperidine), polymethyl vinyl ether, copolymers thereof, and the like may be included.

The temperature-responsive compound can be also exemplified as alkyl substituted cellulose derivatives such as methyl cellulose, ethyl cellulose and hydroxypropyl cellulose, polyalkylene oxide block copolymers such as block copolymers of polypropylene oxide and polyethylene oxide, and the like.

Among the temperature-responsive compounds, from the viewpoint that the terminal group is easily modified by a functional group such as a carboxylic acid group, an amine group, and a maleimide group, or pH responsiveness can be imparted by copolymerization with a methacrylic acid, or the like, a polymer having a constituent unit derived from N-substituted (meth)acrylamide is preferred.

These temperature-responsive compounds are not particularly limited, however, these temperature-responsive compounds can be obtained by polymerizing a monomer by radiation irradiation or by solution polymerization.

As the monomer, those which are polymerized to obtain a homopolymer representing temperature responsiveness (hereinafter, also referred to as “temperature-responsive monomer”) can be used. The temperature-responsive monomer is not particularly limited, however, for example, may be an N-(or N,N-di) substituted (meth)acrylamide compound, a (meth)acrylamide compound having a cyclic group, a vinyl ether compound, or the like. The temperature-responsive compound may be a homopolymer obtained by polymerizing one temperature-responsive monomer, or a copolymer obtained by polymerizing two or more temperature-responsive monomers. The copolymer may be any one of graft copolymer, a block copolymer and a random copolymers.

In addition, the temperature-responsive compound may be if necessary, a copolymer obtained by copolymerizing the temperature-responsive monomer; and a monomer component which is not the temperature-responsive monomer itself, within a range not inhibiting the temperature responsiveness. The copolymer may be any one of a random copolymer, a block copolymer, and a graft copolymer.

In addition, the temperature-responsive compound may be a crosslinked body of these polymers. When the temperature-responsive polymer is a crosslinked body, the crosslinked body may include, for example, polymers obtained by polymerizing a monomer, for example, N-alkyl(meth)acrylamide such as N-methyl(meth)acrylamide, N-ethyl(meth)acrylamide, N-n-propyl(meth)acrylamide, N-isopropyl(meth)acrylamide, N-n-butyl(meth)acrylamide, N-isobutyl(meth)acrylamide, and N-t-butyl(meth)acrylamide; N-vinyl alkyl amide such as N-vinyl isopropyl amide, N-vinyl-n-propyl amide, N-vinyl-n-butyl amide, N-vinyl isobutyl amide, and N-vinyl-t-butyl amide; vinyl alkyl ether such as vinyl methyl ether, and vinyl ethyl ether; alkylene oxide such as ethylene oxide and propylene oxide; 2-alkyl-2-oxazoline such as 2-ethyl-2-oxazoline, 2-n-propyl-2-oxazoline, and 2-isopropyl-2-oxazoline; or two or more of these monomers, in the presence of a crosslinking agent.

As the crosslinking agent, a conventionally known one can be appropriately selected and used, however, for example, a crosslinkable monomer having a polymerizable functional group such as ethyleneglycol di(meth)acrylate, propyleneglycol di(meth)acrylate, N,N′-methylene bis(meth)acrylamide, tolylene diisocyanate, divinyl benzene and polyethyleneglycol di(meth)acrylate; glutaraldehyde; polyhydric alcohols; polyhydric amines; polyhydric carboxylic acids; metal ions such as a calcium ion and a zinc ion may be preferably used. The crosslinking agent may be used alone or in combination of two or more.

The molecular weight of the temperature-responsive compound is not particularly limited, however, it is preferred that a number average molecular weight measured by gel permeation chromatography (GPC) is 3,000 or more.

The temperature-responsive compound may be used alone or in combination of two or more. In addition, as the temperature-responsive compound, a commercially available product may be used, or a product obtained by synthesis as described above may be used.

The content of the stimulus-responsive compound in the surface layer is preferably 20 to 70% by mass, and more preferably 30-60% by mass, based on total 100% by mass of the stimulus-responsive compound and the resin included in the surface layer. Within the range, strength of the surface layer can be improved, and also rapid stimulus responsiveness can be maintained.

### Other Components

The surface layer according to the present invention may further contain an antioxidant, a plasticizer, metal oxide particles and the like, within the range not inhibiting the effect of the present invention. The thickness (dried thickness) of the surface layer is not particularly limited, however, preferably 3 to 30 μm, and more preferably 5 to 10 μm.

### Adhesive Layer

In the original plate for forming an ink film according to an embodiment of the present invention, the surface layer may be disposed on a support with an adhesive layer interposed therebetween.

An adhesive used for forming the adhesive layer (hereinafter, referred to as an adhesive for forming an adhesive layer) is not particularly limited, and a curable composition including a curable resin, and if necessary, a polymerization initiator, a solvent, and the like is preferred.

The curable resin may be an active energy ray (e.g., ultraviolet ray, visible ray, X ray, electron beam, or the like) curable type or a thermosetting type, however, preferably an active energy ray curable type, and more preferably ultraviolet-curable type. The curable resin may be used alone or in combination of two or more. In addition, as the curable resin, a commercially available product may be used, or a synthetic product may be used.

As the ultraviolet-curable resin, for example, an ultraviolet-curable urethane acrylate resin, an ultraviolet-curable polyester acrylate resin, an ultraviolet-curable epoxy acrylate resin, an ultraviolet-curable polyol acrylate resin, an ultraviolet-curable epoxy resin, and the like are preferably used. Among them, the ultraviolet-curable urethane acrylate resin and the ultraviolet-curable polyol acrylate resin are preferred, and the ultraviolet-curable polyol acrylate resin is more preferred.

The ultraviolet-curable polyol acrylate resin may include ethyleneglycol (meth)acrylate, polyethyleneglycol di(meth)acrylate, glycerin tri(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, alkyl modified dipentaerythritol penta(meth)acrylate, or the like. As the ultraviolet-curable polyol acrylate resin, a commercially available product may be used, and the commercially available product may include SARTOMER® SR295, 350, 399 (manufactured by SARTOMER), or the like.

As the polymerization initiator, known photopolymerization initiator, thermopolymerization initiator, or the like may be appropriately selected and used, depending on the type of the curable resins to be used. As the adhesive for forming the adhesive layer, any one of a commercially available product and a synthetic product may be used.

When the adhesive is cured by irradiating an active energy ray, an irradiation condition (type of light source, an irradiation intensity, an irradiation time, or the like) can be appropriately selected. As a light source, a known light source such as a low pressure mercury lamp, a high pressure mercury lamp, a xenon lamp, and a metal halide lamp can be used. The irradiation intensity is not particularly limited, however, for example, in a range of 10 to 200 mW/cm². In addition, the irradiation time is also not particularly limited, however, is for example, 1 to 10 minutes. Even in the case that the adhesive is cured by heating, heating temperature or heating time can be appropriately adjusted.

The thickness (dried thickness) of the adhesive layer is not particularly limited, however, 0.5 to 3 μm is preferred.

### Method for Manufacturing Original Plate for Forming Ink Film

The method for manufacturing the original plate for forming an ink film is not particularly limited, however, for example, a method in which a solution for forming the surface layer including the stimulus-responsive compound and the resin is prepared, and the solution is coated on the support and dried, thereby preparing the surface layer.

The solvent to be used in the solution for forming the surface layer is not particularly limited, and may include, for example, an aliphatic solvent such as n-pentane, n-hexane, n-heptane, n-octane, cyclohexane, and methyl cyclohexane; a ketone-based solvent such as methyl ethyl ketone, acetone, and cyclohexanone; an ether-based solvent such as diethyl ether, isopropyl ether, tetrahydrofuran, dioxane, ethyleneglycol dimethyl ether, ethyleneglycol diethyl ether, diethyleneglycol dimethyl ether, diethyleneglycol diethyl ether, propylene glycol monomethyl ether, anisole, and phenetol; an ester-based solvent such as ethyl acetate, butyl acetate, ethyleneglycol diacetate; an aromatic solvent such as toluene, and xylene; a cellosolve-based solvent such as methyl cellosolve, ethyl cellosolve, and butyl cellosolve; an alcohol-based solvent such as methanol, ethanol, propanol, and isopropyl alcohol; an ether-based solvent such as tetrahydrofuran, and dioxane; a halogen-based solvent such as dichloromethane and chloroform; a nitrile-based solvent such as acetonitrile and propionitrile; a polar solvent such as N-methyl-2-pyrrolidone, N-ethyl-2-pyrrolidone, N,N-dimethylformamide, and N,N-dimethylacetamide, or the like. These solvents may be used alone or in combination of two or more.

The total content of the resin and the stimulus-responsive compound in the solution for forming the surface layer is not particularly limited, however, 30-60% by mass is preferred.

A method for coating the surface layer on the support may include a spin coating method; a dipping method; a dripping method; a method of using liquid film coating equipment such as a roll coater, a rod coater, a curtain coater, a slide coater, a doctor knife, a screen coater, a slot coater, an extrusion coater, a blade coater, a gravure coater, and an inkjet coater; or the like.

After the coating solution is coated, if necessary, the solution is air dried, and subsequently, dried using a vacuum dryer or the like, thereby obtaining the original plate for forming an ink film. The drying temperature when the vacuum dryer is used is not particularly limited, however, 25 to 40° C. is preferred. In addition, the drying time is not particularly limited, however, 1 to 4 hours are preferred.

When an original plate having an adhesive layer between a support and a surface layer is manufactured, the adhesive layer is provided on the support by the method described in [adhesive layer], and then the surface layer is formed on the adhesive layer.

### Pattern Film Forming Apparatus, and Pattern Film Forming Method

Another embodiment of the present invention is a pattern film forming apparatus (printing apparatus) using the original plate. It is preferred that the pattern film forming apparatus has the original plate for forming an ink film according to an embodiment of the present invention; a writing means for forming a pattern including a hydrophilic portion and a hydrophobic portion, by giving an external stimulus to the surface layer of the original plate; an ink film forming means for forming an ink film on the pattern; a first transfer means for relatively pressing and then releasing a surface for an ink film of a blanket, on the original plate on which the ink film is formed, thereby transferring only the ink film formed on the hydrophobic portion of the pattern to the surface for the ink film of the blanket; and a second transfer means for relatively pressing and then releasing an object to be printed, on the

In addition, another embodiment of the present invention is a pattern film forming method (printing method) using the original plate. It is preferred that the pattern film forming method includes a first writing step of forming a pattern including a hydrophilic portion and a hydrophobic portion, by giving an external stimulus to the surface layer of the original plate for forming an ink film according to an embodiment of the present invention; a step of forming an ink film on the pattern; a step of relatively pressing and then releasing a surface for an ink film of a blanket, on the original plate on which the ink film is formed, thereby transferring only the ink film formed on the hydrophobic portion of the pattern to the surface for the ink film of the blanket; and a step of relatively pressing and then releasing an object to be printed, on the blanket having the transferred ink film, thereby transferring the ink film to the surface of the object to be printed.

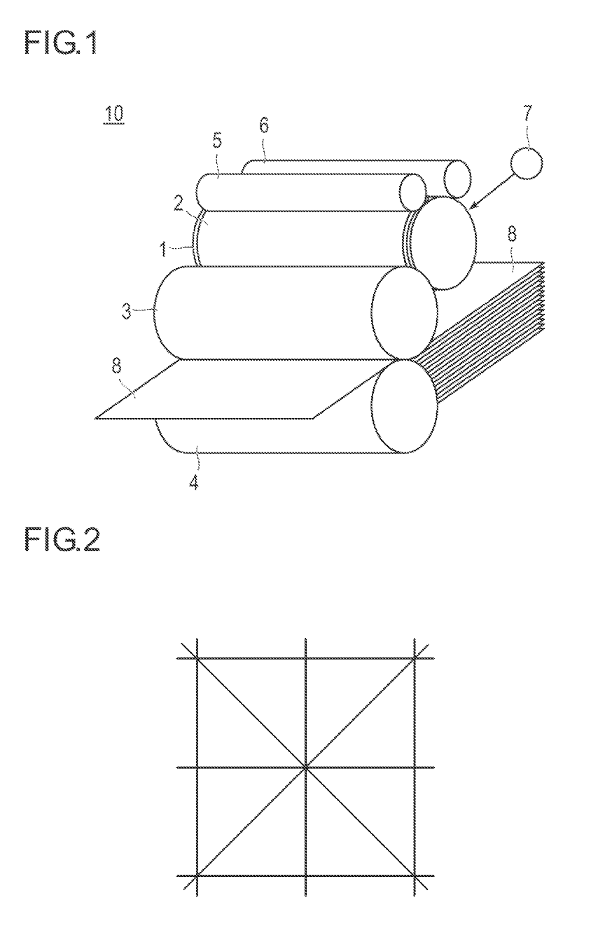

Hereinafter, each means (or step) constituting the pattern film forming apparatus (or method) according to the present invention will be described, appropriately referring to FIG. 1. However, the pattern film forming apparatus to be used in the present invention is not limited to the following forms and illustrations. FIG. 1 is an example using a blanket 3, however, the present invention is not limited thereto, and may have a form in which an ink film is adhered on an original plate 1 mounted on a plate cylinder 2 directly by an ink roller 5 not using the blanket 3 to form an ink film, and then the ink film is directly transferred to the object to be printed. In addition, in the following, an example in which the ink is supplied from above an object to be printed 8, however, the ink may be supplied from below the object to be printed 8.

FIG. 1 is a schematic diagram representing a pattern film forming apparatus 10 according to an embodiment of the present invention. The pattern film forming apparatus 10 has an original plate for forming an ink film 1, a plate cylinder 2, a blanket 3, an impression cylinder 4, an ink roller 5, a water roller 6, and a single color laser light source 7 which is a writing means.

In the pattern film forming method according to an embodiment of the present invention, light emitted from a single color laser light source 7 (external stimulus, an arrow of FIG. 1) is imparted to the surface layer of the original plate 1 mounted on the plate cylinder 2, thereby forming a pattern including a hydrophilic portion and a hydrophobic portion.

After water supplied from the water roller 6 is adhered on the hydrophilic portion formed on the surface layer of the original plate 1, an ink supplied from the ink roller 5 is adhered on the surface layer of the original plate 1 mounted on the plate cylinder 2, at a contact point with the plate cylinder 2. Thus, an ink film is formed on the original plate 1. The formed ink film is transferred to the surface for an ink film of the blanket 3, at a contact point with the blanket 3. The ink film adhered on the blanket 3 is transferred to the object to be printed 8, at a contact point with the object to be printed 8 disposed on the impression cylinder 4. The object to be printed 8 is dried as needed, thereby obtaining a printed matter. Rotation speeds of the ink roller, each cylinder and the blanket are not particularly limited, and can be appropriately set, depending on the ink or the object to be printed.

### Writing Means (First Writing Step and Second Writing Step)

When the surface layer of the original plate 1 includes a photoresponsive compound, the writing means may be a known light source such as a light emitting diode (LED) and a single color laser light source. In addition, when the surface layer of the original plate 1 includes a temperature-responsive compound, the writing means may be an infrared lamp, a single color laser light source, or the like. The means for writing may be installed alone or in combination of two or more.

To the original plate for forming an ink film 1 installed on the plate cylinder 2, an external stimulus is partially given with the writing means, thereby forming a pattern including a hydrophilic portion and a hydrophobic portion on the surface layer of the original plate 1. In the present specification, “partially giving an external stimulus” refers to giving an external stimulus to any one of an image portion and a non-image portion of the image pattern to be written.

As described above, it is preferred that the stimulus-responsive compound according to the present invention is the photoresponsive compound or the temperature-responsive compound. That is, it is preferred that the external stimulus given by the writing means is a light or temperature change.

When the surface layer of the original plate 1 includes the photoresponsive compound, the external stimulus is light. Here, the wavelength range of the light irradiated from the writing means (preferably a single color laser light source) is preferably 200 to 400 nm and more preferably 280 to 400 nm. Within the wavelength range, the light can be irradiated to a finer region, thereby reproducing small letters or fine images more clearly. In addition, since energy received by the surface layer is not too large, the surface layer does not deteriorate easily, and thus, can withstand repetitive rewriting operations.

It is preferred that an irradiation light quantity at the time of writing is for example, in a range of 1 to 10 J/cm². Within the range, small letters or fine images can be clearly written, and the writing can be performed without overloading the surface layer.

When the surface layer of the original plate includes the temperature-responsive compound, the external stimulus is a temperature change. As described above, the temperature-responsive compound to be used in the present invention has a critical solution temperature, and a temperature change is imparted on the surface layer so as to pass the critical solution temperature, thereby forming a pattern including a hydrophilic portion and a hydrophobic portion on the surface layer of the original plate 1. Here, it is preferred that the writing means to be used is a single color laser light source which emits light at a wavelength of 700 to 900 nm. Partial heating is performed by the writing means to form the pattern.

When various light sources are used as the writing means, it is preferred that light emitted from the light source is irradiated in the form of a pin spot, so that only the stimulus-responsive compound to which the external stimulus is given has a changed affinity with water. As the method, for example, an irradiation method of guiding light from the light source to optical fiber may be included. However, it is possible to adopt an irradiation method by projection of an image pattern and the like, as long as a required light quantity can be supplied.

By performing the writing step (first writing step) as described above, the pattern including a hydrophilic portion and a hydrophobic portion is formed on the surface layer of the original plate 1. Therefore, another embodiment of the present invention is a pattern forming method including a first writing step of giving an external stimulus to the surface layer included in the original plate according to an embodiment of the present invention, thereby forming a pattern including a hydrophilic portion and a hydrophobic portion. It is preferred that the external stimulus given in the forming method is light or a temperature change, as described above. In addition, it is preferred that the external stimulus given in the forming method is light at a wavelength in a range of 280 to 400 nm, as described above.

The writing means only needs to be operated when at least the image pattern is changed to print a different printed matter, and in the case that plural sheets of the same printed matter are printed, the writing means does not need to be used. That is, since the pattern formed on the surface layer is maintained as it is by writing once, an ink film is continuously transferred by a transfer means, thereby plural sheets of printing can be performed without involving rewriting. In addition, the pattern formed on the surface layer can be easily rewritten, by performing a second writing step of erasing the pattern by an erasing step described below, and additionally, giving an external stimulus to the same surface layer, thereby forming a pattern including a hydrophilic portion and a hydrophobic portion. As such, by repeating the erasing step and the writing step, a plurality of printed patterns can be formed on the surface of one original plate. The original plate according to an embodiment of the present invention has excellent durability in that small letters or fine images can be printed clearly and reproducibly, even in the case or repeating the steps.

The pattern including a hydrophilic portion and a hydrophobic portion formed on the surface layer of the original plate 1 is moved with rotation of the plate cylinder 2, thereby being provided for forming the ink film.

### Ink Film Forming Means (Step)

In the pattern film forming apparatus according to an embodiment of the present invention, the ink film forming means is for example, an ink roller 5 as shown in FIG. 1.

The ink film forming means is to form the ink film by coating an ink on the pattern formed in the writing step. In the present specification, “forming an ink film” means that the ink is maintained at a predetermined position of the pattern (hydrophilic portion or hydrophobic portion), in a transferable state on the object to be printed 8.

The ink is not particularly limited as long as it is transferable to the object to be printed 8, and a known ink such as an aqueous ink, an oil-based ink, and an emulsion ink may be used. When the aqueous ink is used, the ink film is formed on the hydrophilic portion of the pattern. When the oil-based ink or emulsion ink is used, the ink film is formed on the hydrophobic portion of the pattern.

The formed ink film is moved with rotation of the plate cylinder 2 on which the original plate 1 is installed, and sent so as to be in contact with the blanket 3.

### First Transfer Means (Step)

In the pattern film forming apparatus according to an embodiment of the present invention, the first transfer means is, for example, the blanket 3, as shown in FIG. 1.

In the first transfer step, a surface for the ink film of the blanket 3 is relatively pressed and then released, on the original plate 1 on which the ink film is formed in the ink film forming step, thereby transferring the ink film formed on the pattern.

As described above, the position at which the ink film is formed may be a hydrophilic portion or a hydrophobic portion, depending on the type of ink, however, from the viewpoint that a hydrophobic ink has relatively high viscosity, whereby image collapse is difficult to occur at the time of transferring, the form in which only the ink film on the hydrophobic portion is transferred to the blanket is preferred.

The material of the blanket 3 is not particularly limited, as long as the ink film is transferred, and a known material may be used.

The ink film remained on the blanket 3 is removed, for example, by a clearing blade (not shown), or the like.

### Second Transfer Means (Step)

In the pattern film forming apparatus according to an embodiment of the present invention, the second transfer means is an impression cylinder 4, for example, as shown in FIG. 1.

In the second transfer step, an object to be printed 8 is relatively pressed and then released by an impression cylinder 4, on the blanket 3 having a transferred ink film, thereby transferring the ink film to the surface of the object to be printed 8.

The material of the impression cylinder 4 is not particularly limited, and a known material may be used.

The object to be printed 8 is not particularly limited as long as the ink film is transferred thereto, and for example, the object may include paper or a resin film, a plate made of a resin or a metal (such as a sheet), cloth, or the like.

### Erasing Means (Step)

It is further preferred that the pattern film forming apparatus according to an embodiment of the present invention has an erasing means for erasing a pattern by giving an external stimulus to the surface layer of the original plate 1.

When the surface layer of the original plate includes the photoresponsive compound, the erasing means may be, from the viewpoint of a rate of change of an affinity with water, a single color laser light source or a light emitting diode emitting visible light (preferably visible light at a wavelength in a range of 400 to 600 nm).

When the surface layer of the original plate includes the temperature-responsive compound, as the erasing means, for example, a cold air generator which can generate cold air at 5 to 20° C., a thermostatic bath at 5 to 20° C., or the like may be included.

The pattern is erased by the erasing means, so that the surface layer of the original plate has the same characteristic as that before the external stimulus was given. Thereafter, the writing step is performed again, thereby forming a new pattern on the surface layer. That is, the original plate according to an embodiment of the present invention is easy to digitally rewrite a pattern thereon.

Therefore, it is preferred that the pattern film forming method according to the present invention further has an erasing step, following the transfer steps, of giving an external stimulus to the surface layer included in the original plate, thereby erasing a pattern. In addition, it is preferred that the external stimulus used in the present erasing step is light or a temperature change. In addition, it is preferred that the external stimulus used in the present erasing step is visible light.

The erasing means is only needed to change an image pattern, so as to be operated when printing a different printed matter, and when plural sheets of the same printed matter are printed, the erasing means does not have to be used. As described above, the pattern formed on the surface layer by the first writing step is erased by the erasing step, the external stimulus is given to the same surface layer, and the second writing step of forming a pattern including hydrophilic portion and a hydrophobic portion is further performed, thereby making easy rewriting possible. As such, by repeating the erasing step and the writing step, a plurality of print patterns can be formed on one surface of the original plate. The original plate according to an embodiment of the present invention has excellent durability, in that even in the case of repeating the steps, small letters or fine images can be printed clearly and reproducibly.

The writing means and the erasing means may be installed in the same case as the case in which the plate cylinder 2, the blanket 3, and the impression cylinder 4 are installed, or outside the case in which the plate cylinder 2, the blanket 3, and the impression cylinder 4 are installed. When the writing means and the erasing means are installed in the same case as the case in which the plate cylinder 2, the blanket 3, and the impression cylinder 4 are installed, the first writing step, the erasing step, and also the subsequent second writing step on the surface layer of the original plate 1 installed in the plate cylinder 2 can be continuously repetitively performed. When the same image pattern is intended to be continuously printed, it is possible to perform printing without performing the erasing step and the subsequent second writing step. In addition, after transfer to the object to be printed 8 once, the erasing step is conducted, and the same image is written on the surface layer of the original plate 1, thereby also making it possible to continuously print the same image pattern.

The pattern film forming apparatus (method) according to an embodiment of the present invention may have the means (step) other than the above means (steps). For example, in the pattern film forming method, a method in which the external stimulus is given to the entire surface layer of the original plate, before the first writing step, thereby performing a step of changing an affinity of the stimulus-responsive compound included in the entire surface layer with water (hydrophobicity→hydrophilicity, or hydrophilicity→hydrophobicity), and the step after the first writing step is performed, may be adopted.

### EXAMPLES

The effects of the present invention will be described using the following Examples and the Comparative Examples. However, the technical scope of the present invention is not limited only to the following Examples. In the following Examples, unless otherwise stated, “part” and “%” represent “parts by mass” or “% by mass”, respectively.

### Synthesis of Azobenzene Compound Represented by Chemical Formula 2 (Azobenzene Derivative (1))

75 mL of 2.4 N hydrochloric acid is added to 4-amino-2-chlorophenol (8.61 g, 60 mmol), which is then added to a solution of sodium nitrite (4.98 g, 72 mmol) dissolved in 6 mL of distilled water, while cooling and stirring at 0° C., and stirring was continued at 0° C. for 60 minutes. To this solution, a mixed solution of 2-chlorophenol (7.71 g, 60 mmol) and 24 mL of a 20% aqueous sodium hydroxide solution was added, and stirred for 20 hours. Precipitates were filtered, and a solid was washed with water. The obtained solid was purified by silica gel column chromatography using a mixed solution of ethyl acetate and hexane as a developing solvent, thereby obtaining Intermediate A (see Reaction Formula A for its structure). To Intermediate A (2.83 g, 10 mmol), 100 mL of DMF, 1-bromohexane (9.90 g, 60 mmol), and potassium carbonate (6.91 g, 50 mmol) were added, which were stirred at 80° C. for 2 hours, and continuously stirred at room temperature (25° C.) for 20 hours. After distilling the solvent under a reduced pressure, the product was extracted with ethyl acetate, and an organic layer was washed with saturated saline and dried with anhydrous magnesium sulfate. After filtering, the solvent was distilled under a reduced pressure, and the obtained solid was purified by silica gel column chromatography using a mixed solution of ethyl acetate and hexane as a developing solvent, thereby obtaining Intermediate B (see Reaction Formula A for its structure). To Intermediate B (2.58 g, 5 mmol), 12 mL of a 20% aqueous sodium hydroxide solution was added, which was stirred at 340° C., 150 atm (15.2 MPa) for 2 hours, and 10 mL of 1.2 N hydrochloric acid was added thereto, which was stirred for 1 hour at room temperature (25° C.). The product was extracted with ethyl acetate, and an organic layer was washed with saturated saline and then dried with anhydrous magnesium sulfate. After filtering, the solvent was distilled under a reduced pressure, and the obtained solid was purified by silica gel column chromatography using a mixed solution of ethyl acetate and hexane as a developing solvent, thereby obtaining azobenzene derivative (1) (see Chemical Formula 2).

### Synthesis of Azobenzene Compound Represented by Chemical Formula 6 (Azobenzene Derivative (Polymer 2))

After 75 mL of 2.4 N hydrochloric acid was added to 3-chloro-4-(hexyloxy) aniline (13.66 g, 60 mmol), a solution of sodium nitrite (4.98 g, 72 mmol) dissolved in 6 mL of distilled water was added while cooling and stirring at 0° C., and continuously stirred at 0° C. for 60 minutes. To this solution, a mixed solution of 2-chlorophenol (7.71 g, 60 mmol) and 24 mL of a 20% aqueous sodium hydroxide solution was added, and stirred for 20 hours. Precipitates were filtered, and a solid was washed with water. The obtained solid was purified by silica gel column chromatography using a mixed solution of ethyl acetate and hexane as a developing solvent, thereby obtaining Intermediate C (see Reaction Formula C for its structure). To Intermediate C (7.35 g, 20 mmol), 100 mL of DMF, 3-bromo-1-hexanol (10.9 g, 60 mmol), and potassium carbonate (6.91 g, 50 mmol) were added, which were stirred at 80° C. for 2 hours, and continuously stirred at room temperature (25° C.) for 20 hours. After the solvent was distilled under a reduced pressure, the product was extracted with ethyl acetate, and an organic layer was washed with saturated saline and then dried with anhydrous magnesium sulfate. After filtering, the solvent was distilled under a reduced pressure, and the obtained solid was purified by silica gel column chromatography using a mixed solution of ethyl acetate and hexane as a developing solvent, thereby obtaining Intermediate D (see Reaction Formula C for its structure). To Intermediate D (4.67 g, 10 mmol), 100 mL of tetrahydrofuran was added, thereby preparing a tetrahydrofuran solution of Intermediate D. Separately, when acryloyl chloride (1.09 g, 12 mmol) and triethylamine (2.43 g, 24 mmol) were added, a tetrahydrofuran solution of Intermediate D was dropped at 0° C., and continuously stirred at 0° C. for 30 minutes, then heated to room temperature (25° C.), and further stirred at room temperature (25° C.) for 2 hours. The obtained reaction solution was washed with water and saturated saline, the solvent was distilled under a reduced pressure, and recrystallized with methanol, thereby obtaining Intermediate E. To Intermediate E (2.61 g, 5 mmol), 12 mL of a 20% aqueous sodium hydroxide solution was added, which was stirred at 340° C., and 150 atm (15.2 MPa) for 2 hours, and 10 mL of 1.2 N hydrochloric acid was added thereto, which was stirred for 1 hour at room temperature (25° C.). The product was extracted with ethyl acetate, and an organic layer was washed with saturated saline and then dried with anhydrous magnesium sulfate. After filtering, the solvent was distilled under a reduced pressure, and the obtained solid was purified by silica gel column chromatography using a mixed solution of ethyl acetate and hexane as a developing solvent, thereby obtaining Intermediate F. To Intermediate F (1.45 g, 3 mmol), 40 mL of a mixed solvent of benzene/tetrahydrofuran (mass ratio of 1:1) was added, and further 20% by mass of 2,2-azobis isobutyronitrile (AIBN) as a polymerization initiator was added relative to Intermediate F, and stirred at 70° C. for 20 hours. Thereafter, reprecipitation using ethanol produced an azobenzene derivative (Polymer 2) (see Chemical Formula 6). Obtained Polymer 2 has x of about 500, which is the number of repeating units in Chemical Formula 6.

### Synthesis of Azobenzene Compound Represented by Chemical Formula 3 (Azobenzene Derivative (3))

To Intermediate B (2.26 g, 5 mmol), 20 mL of liquid ammonia and potassium amide (0.33 g, 6 mmol) were added, and stirred at room temperature (25° C.) for 5 hours. The obtained reaction solution was extracted with ethyl acetate, and an organic layer was washed with saturated saline and then dried with anhydrous magnesium sulfate. After filtering, the solvent was distilled under a reduced pressure, and the obtained solid was purified by silica gel column chromatography using a mixed solution of ethyl acetate and hexane as a developing solvent, thereby obtaining azobenzene derivative (3) (see Chemical Formula 3).

### Example 1: Manufacture of Original Plate for Forming Ink Film (M-1))

1200 parts by mass of dichloromethane, 1200 parts by mass of toluene, 380 parts by mass of azobenzene derivative (1) synthesized above as the photoresponsive compound, and 1520 parts by mass of a styrene acryl resin (manufactured by SEIKO PMC CORPORATION, US-1071, weight average molecular weight: 10,000) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 nm. After coating, the product was air-dried for 30 minutes, and dried at 30° C. for 2 hours using a vacuum dryer, thereby obtaining an original plate for forming an ink film (M-1).

### Example 2: Manufacture of Original Plate for Forming Ink Film (M-2))

1200 parts by mass of dichloromethane, 1200 parts by mass of toluene, 570 parts by mass of azobenzene derivative (1) synthesized above as the photoresponsive compound, and 1330 parts by mass of a styrene acryl resin (manufactured by SEIKO PMC CORPORATION, US-1071, weight average molecular weight: 10,000) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and dried at 30° C. for 2 hours using a vacuum dryer, thereby obtaining an original plate for forming an ink film (M-2).

### Example 3: Manufacture of Original Plate for Forming Ink Film (M-3))

600 parts by mass of dichloromethane, 600 parts by mass of toluene, 570 parts by mass of azobenzene derivative (1) synthesized above as the photoresponsive compound, and 380 parts by mass of a styrene acryl resin (manufactured by SEIKO PMC CORPORATION, US-1071) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-3).

### Example 4: Manufacture of Original Plate for Forming Ink Film (M-4))

600 parts by mass of dichloromethane, 600 parts by mass of toluene, 1330 parts by mass of azobenzene derivative (1) synthesized above as the photoresponsive compound, and 380 parts by mass of a styrene acryl resin (manufactured by SEIKO PMC CORPORATION, US-1071) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-4).

### Example 5: Manufacture of Original Plate for Forming Ink Film (M-5))

1200 parts by mass of dichloromethane, 1200 parts by mass of toluene, 570 parts by mass of azobenzene derivative (Polymer 2) synthesized above as the photoresponsive compound, and 1330 parts by mass of a styrene acryl resin (manufactured by SEIKO PMC CORPORATION, US-1071) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-5).

### Example 6: Manufacture of Original Plate for Forming Ink Film (M-6))

1200 parts by mass of tetrahydrofuran, 1200 parts by mass of toluene, 570 parts by mass of poly(N-isopropyl acrylamide) (manufactured by SIGMA-ALDRICH, 806471-1 G) as the temperature-responsive compound, and 1330 parts by mass of a styrene acryl resin (manufactured by SEIKO PMC CORPORATION, US-1071) as the thermoplastic resin were stirred and mixed at room temperature (25° C.) for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-6).

### Example 7: Manufacture of Original Plate for Forming Ink Film (M-7))

1200 parts by mass of dichloromethane, 1200 parts by mass of toluene, 570 parts by mass of azobenzene derivative (1) synthesized above as the photoresponsive compound, and 1330 parts by mass of a solid epoxy resin (manufactured by DIC Corporation, 7050) as the thermosetting resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30 ° C. for 2 hours using a vacuum dryer, thereby obtaining an original plate for forming an ink film (M-7).

### Example 8: Manufacture of Original Plate for Forming Ink Film (M-8))

1200 parts by mass of dichloromethane, 1200 parts by mass of toluene, 570 parts by mass of azobenzene derivative (3) obtained above as the photoresponsive compound, and 1330 parts by mass of a styrene acryl resin (manufactured by SEIKO PMC CORPORATION, US-1071) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-8).

### Example 9: Manufacture of Original Plate for Forming Ink Film (M-9))

1200 parts by mass of dichloromethane, 1200 parts by mass of toluene, 570 parts by mass of stilbene derivative (1) represented by Chemical Formula 5 (manufactured by Tokyo Chemical Industry Co., Ltd., product code: 10804, Isorhapontigenin) as the photoresponsive compound, and 1330 parts by mass of a styrene acryl resin (manufactured by SEIKO PMC CORPORATION, US-1071) as the thermoplastic resin were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-9).

### Comparative Example 1: Manufacture of Original Plate for Forming Ink Film (M-10))

360 parts by mass of dichloromethane, 360 parts by mass of toluene, and 570 parts by mass of azobenzene derivative (1) obtained above as the photoresponsive compound were stirred and mixed at 50° C. for 1 hour, thereby obtaining a solution. This solution was dispersed well at room temperature (25° C.) for 30 minutes using a paint shaker and coated on an electrolytically polished planar aluminum substrate (length of 360 mm×width of 180 mm) as the support using a blade coater so that a thickness after drying was 6 μm. After coating, the product was air-dried for 30 minutes, and then dried at 30° C. for 2 hours using a vacuum dryer, thereby obtaining an original plate for forming an ink film (M-10).

The constitutions of original plate for forming an ink films (M-1) to (M-10) are shown in the following Table 1. “Content of stimulus-responsive compound” represents a content of the stimulus-responsive compound relative to total mass of the stimulus-responsive compound and the resin in the surface layer.

TABLE 1

| | Original plate | | | Content of | |
|---|---|---|---|---|---|
| | for forming ink | | | stimulus-responsive | |
| | film No. | Stimulus-responsive compound | Resin | compound | Surface layer |
| Example 1 | M-1 | Azobenzene derivative (1) | Styrene acryl resin | 20% by mass | Hydrophobic |
| Example 2 | M-2 | Azobenzene derivative (1) | Styrene acryl resin | 30% by mass | Hydrophobic |
| Example 3 | M-3 | Azobenzene derivative (1) | Styrene acryl resin | 60% by mass | Hydrophobic |
| Example 4 | M-4 | Azobenzene derivative (1) | Styrene acryl resin | 70% by mass | Hydrophobic |
| Example 5 | M-5 | Azobenzene derivative (Polymer 2) | Styrene acryl resin | 30% by mass | Hydrophobic |
| Example 6 | M-6 | Poly(N-isopropyl acrylamide) | Styrene acryl resin | 30% by mass | Hydrophilic |
| Example 7 | M-7 | Azobenzene derivative (1) | Solid epoxy resin | 30% by mass | Hydrophobic |
| Example 8 | M-8 | Azobenzene derivative (3) | Styrene acryl resin | 30% by mass | Hydrophobic |
| Example 9 | M-9 | Stilbene derivative (1) | Styrene acryl resin | 30% by mass | Hydrophobic |
| Comparative | M-10 | Azobenzene derivative (1) | — | 100% by mass | Hydrophobic |
| Example 1 | | | | | |

### Example 10

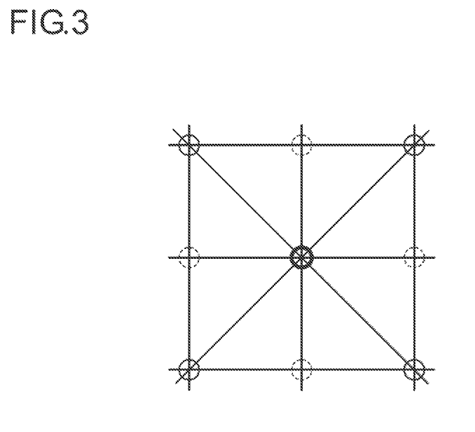

On the surface of the plate cylinder of the pattern film forming apparatus having the constitution as shown in FIG. 1, the adhesive layer was provided, and additionally, the original plate for forming an ink film (M-1) was tied thereto to be installed, and the non-image portion of the image pattern (width of fine line: 0.1 mm) shown in FIG. 2 was irradiated with single color laser light at a wavelength of 365 nm at an irradiation amount of 2 J/cm². Thus, the surface for forming an ink film (m10) having a pattern in which the light irradiation portion, that is, the non-image portion, is the hydrophilic portion, and the image portion is the hydrophobic portion was formed.

On the image portion (hydrophobic portion) of the surface for forming an ink film (m10), a hydrophobic ink was coated using an ink roller to form the ink film. The surface of an ink film of a blanket was relatively pressed and then released, on the original plate for forming an ink film (M-1) having the ink film, thereby transferring the ink film to the blanket. J paper A3 as the object to be printed was relatively pressed and then released, on the blanket having the ink film, thereby transferring the ink film to the surface of the paper to obtain a printed image (this printed image being referred to “an initial print image”, hereinafter the same applied). In addition, 1000 sheets of the printed image were continuously output (the 1000^{th} sheet of the printed image being referred to as “a print image after 1000 sheets of image output”, hereinafter the same applied). Thereafter, as the erasing step, the entire surface for forming the ink film (m10) was irradiated with single color laser light at a wavelength of 365 nm. After light irradiation, water was coated on the entire surface for forming the ink film (m10) using a water roller, and as a result, it was confirmed that the same hydrophobic surface as the original plate before the writing operation was obtained.

In addition, by writing by irradiating a non-image portion of the output image with single color laser light at a wavelength of 365 nm at an irradiation amount of 2 J/cm², the photoresponsive compound was structurally changed (photoisomerized), thereby forming a pattern in which the non-image portion is a hydrophilic portion, and the image portion is a hydrophobic portion.

On the hydrophobic portion of the pattern, an ink was coated using an ink roller to form an ink film. The surface for the ink film of the blanket was relatively pressed and released, on the original plate having the ink film, thereby transferring the ink film to the blanket. In addition, paper as the object to be printed was relatively pressed and then released, on the blanket having the ink film, thereby transferring the ink film to the surface of the paper to obtain a printed image, and 1000 sheets of the printed image were continuously output (the 1000^{th} sheet of the printed image being referred to as “a print image after writing step and 1000 sheets of image output”, hereinafter the same applied).

### Examples 11 to 14, Examples 16 to 18, and Comparative Example 2

The printed image was output in the same manner as in Example 10, except that the original plate for forming an ink film was changed as shown in the following Table 2.

### Example 15

On the plate cylinder of the pattern film forming apparatus having the constitution as shown in FIG. 1, the original plate for forming an ink film (M-6) was installed, and the image portion of the output image was irradiated with single color laser light at a wavelength of 800 nm so that the temperature of the image portion of the output image was 40° C. By the light irradiation, the image portion was heated to be the hydrophobic portion, and the non-image portion which was not irradiated with light (not heated) was the hydrophilic portion, thereby forming a pattern. As such, the surface for forming an ink film (m15) was manufactured.

On the image portion (hydrophobic portion) of the surface for forming an ink film (m15), a hydrophobic ink was coated using an ink roller, thereby forming the ink film. The surface for the ink film of a blanket was relatively pressed and then released, on the original plate having the ink film (M-6), thereby transferring the ink film to the blanket. Paper as an object to be printed was relatively pressed and then released, on the blanket having the ink film, thereby transferring the ink film to the surface of the paper to obtain a printed image. In addition, 1000 sheets of the printed image were continuously output. Thereafter, cold air generated from a cold air generator (cold air temperature: 10° C.) was brought into contact with the surface for forming the ink film (m15), thereby making the temperature of the surface (m15) 30° C. Thereafter, on the entire surface for forming the ink film (m15), water was coated using a water roller, and as a result, it was confirmed from a uniformly wet surface that the same hydrophilic surface as the original plate before writing operation was obtained.

In addition, by writing by irradiating the image portion with single color laser light at a wavelength of 800 nm so as to have the irradiation portion of 40° C., so that the temperature of the image portion of the output image is 40° C., a pattern in which the image portion is the hydrophobic portion, and the non-image portion which was not irradiated with light is the hydrophilic portion was formed.

On the hydrophobic portion of the pattern, an ink was coated using an ink roller to form an ink film. The surface for the ink film of a blanket was relatively pressed and then released, on the original plate having the ink film, thereby transferring the ink film to the blanket. In addition, paper as an object to be printed was relatively pressed and then released, on the blanket having the ink film, thereby transferring the ink film to the surface of the paper to obtain a printed image, and 1000 sheets of the printed image were continuously output.

### Example 19

On the plate cylinder of the pattern film forming apparatus as shown in FIG. 1, the original plate for forming an ink film (M-2) was installed, and the entire surface layer of the original plate (M-2) was irradiated with single color laser light at a wavelength of 365 nm at an irradiation amount of 2 J/cm². This made the entire surface layer of the original plate (M-2) the hydrophilic portion. Subsequently, the image portion of the output image shown in FIG. 2 was irradiated with single color laser light at a wavelength of 465 nm at an irradiation amount of 2 J/cm². This formed the surface for forming the ink film (m19) having the pattern in which the light irradiated portion, that is, the image portion, is the hydrophobic portion, and the non-image portion is the hydrophilic portion.

On the image portion (hydrophobic portion) of the surface for forming an ink film (m19), an ink was coated using an ink roller, thereby forming the ink film. The surface for the ink film of the blanket was relatively pressed and then released, on the original plate for forming an ink film (M-2) having the ink film, thereby transferring the ink film to the blanket. In addition, paper as the object to be printed was relatively pressed and then released, on the blanket having the ink film, thereby transferring the ink film to the surface of the paper to obtain a printed image. In addition, 1000 sheets of the printed image were continuously output. Thereafter, as the erasing step, the surface for forming the ink film (m19) was irradiated with single color laser light at a wavelength of 365 nm. After light irradiation, on the entire surface for forming the ink film (m19), water was coated using a water roller, and as a result, it was confirmed from a uniformly wet surface that the same hydrophilic surface as the original plate before writing operation was obtained.

In addition, by writing by irradiating the non-image portion of the output image with single color laser light having a wavelength of 465 nm at an irradiation amount of 2 J/cm², the photoresponsive compound was structurally changed (photoisomerized), thereby forming a pattern in which the light irradiated portion, that is, the non-image portion, is a hydrophilic portion, and the image portion is a hydrophobic portion.

On the hydrophobic portion of the pattern, an ink was coated using an ink roller, thereby forming an ink film. The surface for the ink film of a blanket was relatively pressed and then released, on the original plate having the ink film, thereby transferring the ink film to the blanket. In addition, paper as an object to be printed was relatively pressed and released, on the blanket having the ink film, thereby transferring the ink film to the surface of the paper to obtain a printed image, and 1000 sheets of the printed image were continuously output.

### Evaluation Method

### Fine Line Reproducibility

The “initial print image”, the “print image after 1000 sheets of image output”, and the “print image after writing step and 1000 sheets of image output” of the image pattern obtained above were magnified with DIGITAL MICROSCOPE, “VHX-600” (manufactured by KEYENCE CORPORATION). From the thus-obtained monitor image, a line width of fine lines, or a line width of fine lines at the intersection was observed by an indicator, and ranked according to the following standard. A-D are passing ranks. In addition, FIG. 3 is a drawing representing an intersection of the fine lines used for evaluation, and a thick solid circle represents an intersection of 4 straight lines, a thin solid circle represents an intersection of 3 straight lines, and a dashed circle represents an intersection of 2 straight lines.

A: A part where the line width is thick in the fine line or at the intersection was not seen.

B: A line at the intersection of 4 straight lines was thick.

C: A line at the intersection of 3 straight lines was thick.

D: A line at the intersection of 2 straight lines was thick.

E: A fine line itself was thick.

The evaluation results are shown in the following Table 2.

TABLE 2

| | | | | Evaluation results | | |
|---|---|---|---|---|---|---|
| | | | | | Print | Print image |
| | Original | | | | image | after |
| | plate for | Surface | | | after 1000 | writing step |
| | forming | layer | Portion | Initial | sheets of | and 1000 |
| | ink | before | to which external | print | image | sheets of |
| | film | writing | stimulus is given | image | output | image output |
| Example 10 | M-1 | hydrophobic | non-image portion | A | A | B |
| Example 11 | M-2 | hydrophobic | non-image portion | A | A | A |
| Example 12 | M-3 | hydrophobic | non-image portion | A | A | A |
| Example 13 | M-4 | hydrophobic | non-image portion | A | B | B |
| Example 14 | M-5 | hydrophobic | non-image portion | A | A | A |
| Example 15 | M-6 | hydrophilic | image portion | B | B | C |
| Example 16 | M-7 | hydrophobic | non-image portion | C | C | D |
| Example 17 | M-8 | hydrophobic | non-image portion | A | B | B |
| Example 18 | M-9 | hydrophobic | non-image portion | A | A | A |
| Example 19 | M-2 | hydrophilic | Image portion | B | B | B |
| Comparative | M-10 | hydrophobic | non-image portion | A | E | E |
| Example 2 | | | | | | |

As clearly seen from the above Table 2, it was found that when the original plate of the present invention is used, it is easy to digitally rewrite the pattern, and the original plate has excellent durability. Example 19 is an example in which the entire surface of the surface layer included in the original plate M-2 was irradiated with light, and the surface layer was made hydrophilic once, and then the pattern film was formed, however, in this case also, it was found that the original plate of the present invention has good durability.

Although embodiments of the present invention have been described and illustrated in detail, the disclosed embodiments are made for the purpose of illustration and example only and not limitation. The scope of the present invention should be interpreted by terms of the appended claims.

What is claimed is:

1. An original plate for forming an ink film comprising:
a surface layer including a stimulus-responsive compound which responds to an external stimulus to have reversibly changed affinity with water; and a resin.

2. The original plate for forming an ink film as claimed in claim 1,
wherein the stimulus-responsive compound is a photoresponsive compound or a temperature-responsive compound.

3. The original plate for forming an ink film as claimed in claim 2,
wherein the photoresponsive compound is an azobenzene compound having a hydrophilic group or a stilbene compound having a hydrophilic group.

4. The original plate for forming an ink film as claimed in claim 3,
wherein the hydrophilic group is a hydroxy group.

5. The original plate for forming an ink film as claimed in claim 2,
wherein the temperature-responsive compound is a polymer having a constituent unit derived from N-substituted (meth)acrylamide.

6. The original plate for forming an ink film as claimed in claim 1,
wherein the resin is a thermoplastic resin.

7. The original plate for forming an ink film as claimed in claim 1,
wherein a content of the stimulus-responsive compound in the surface layer is 20 to 70% by mass, based on total 100% by mass of the stimulus-responsive compound and the resin included in the surface layer.

8. The original plate for forming an ink film as claimed in claim 1,
wherein a content of the stimulus-responsive compound in the surface layer is 30 to 60% by mass, based on total 100% by mass of the stimulus-responsive compound and the resin included in the surface layer.

9. A pattern forming method comprising:
a first writing step of giving an external stimulus to a surface layer included in the original plate for forming an ink film as claimed in claim 1, to form a pattern including a hydrophilic portion and a hydrophobic portion.

10. The pattern forming method as claimed in claim 9,
wherein the external stimulus is light or a temperature change.

11. The pattern forming method as claimed in claim 9,
wherein the external stimulus is light at a wavelength of 280 to 400 nm.

12. The pattern forming method as claimed in claim 9,
wherein the pattern including the hydrophilic portion and the hydrophobic portion is rewritten by further performing:
an erasing step of giving the external stimulus to the pattern to erase the pattern; and
after the erasing step, a second writing step of giving the external stimulus to form the pattern including the hydrophilic portion and the hydrophobic portion.

13. A pattern film forming method comprising:
a first writing step of giving an external stimulus to a surface layer of an original plate for forming an ink film, to form a pattern including a hydrophilic portion and a hydrophobic portion;
a step of forming an ink film on the pattern;
a first transfer step of relatively pressing and then releasing a surface for the ink film of a blanket, on the original plate on which the ink film is formed, to transfer only the ink film formed on the hydrophobic portion of the pattern to the surface for the ink film of the blanket; and
a second transfer step of relatively pressing and then releasing an object to be printed, on the blanket having the transferred ink film, to transfer the ink film to a surface of the object to be printed;
wherein the original plate for forming an ink film as claimed in claim 1 is used as the original plate for forming an ink film.

14. The pattern film forming method as claimed in claim 13, after the step of transferring the ink film to the surface of the object to be printed, further comprising an erasing step of giving the external stimulus to the pattern to erase the pattern.

15. The pattern film forming method as claimed in claim 14,
wherein the external stimulus used in the erasing step is light or a temperature change.

16. The pattern film forming method as claimed in claim 14,
wherein the external stimulus used in the erasing step is visible light.

17. The pattern film forming method as claimed in claim 14,
wherein the pattern is rewritten by, after the erasing step, further performing a second writing step of giving the external stimulus to form the pattern including the hydrophilic portion and the hydrophobic portion.

18. A pattern film forming apparatus comprising:
an original plate for forming an ink film;
a writing means for giving an external stimulus to a surface layer of the original plate to form a pattern including a hydrophilic portion and a hydrophobic portion;
an ink film forming means for forming an ink film on the pattern;
a first transfer means for relatively pressing and then releasing a surface for the ink film of a blanket, on the original plate on which the ink film is formed, to transfer only the ink film formed on the hydrophobic portion of the pattern to the surface for the ink film of the blanket; and
a second transfer means for relatively pressing and then releasing an object to be printed, on the blanket having the transferred ink film, to transfer the ink film to a surface of the object to be printed;
wherein the original plate for forming an ink film is the original plate for forming an ink film as claimed in claim 1.

19. The pattern film forming apparatus as claimed in claim 18, further comprising an erasing means for giving the external stimulus to the pattern to erase the pattern.

20. The pattern film forming apparatus as claimed in claim 18,
wherein the pattern including the hydrophilic portion and the hydrophobic portion is rewritten by further performing:
an erasing step of giving the external stimulus to the pattern to erase the pattern; and
after the erasing step, a writing step of giving the external stimulus to form the pattern including the hydrophilic portion and the hydrophobic portion.
